(19) United States
(12) Patent Application Publication
(10) Pub. No.: US 2010/0318221 A1
(43) Pub. Date: Dec. 16, 2010

(54) QUALITY CONTROL SYSTEM FOR BEVERAGE DISPENSER

(76) Inventors: Klaus Wiemer, Muelheim (DE); Heinz Altenbach, Leverkusen (DE)

Correspondence Address: PYLE & PIONTEK LLC, 221 N. LASALLE STREET, SUITE 1207, CHICAGO, IL, 60601, US

(21) Appl. No.: 12/735,406

(22) PCT Filed: Jan. 15, 2008
(86) PCT No.: PCT/GB2008/000106

§ 371 Date: Jul. 14, 2010

(51) Int. Cl. G06F 17/00; G08B 21/00

(52) U.S. Cl. 700/240; 340/540

(57) ABSTRACT

A beverage dispense system has sensors 15,16,17,27 for monitoring one or more characteristics relating to dispense of a beverage and outputting a signal representative of the or each monitored characteristic, and a control system 56 responsive to signals received from the sensors 15,16,17,27 for controlling operation of the dispense system.

This invention relates to beverage dispense and has particular, but not exclusive, application to the field of soft drinks which are typically dispensed chilled. More especially, the invention concerns the dispense of post-mix beverages such as colas and flavoured sodas in which a concentrate such as a syrup or flavour is mixed with a diluent, typically still or carbonated water, at the point of dispense.

The concentrate and diluent are typically mixed in the correct proportions in a post-mix dispense valve for dispense of the beverage at a dispense outlet of a counter top fitting such as a dispense tower. The tower may have multiple outlets for dispense of the same or different beverages.

Usually the beverage ingredients are delivered to the tower in separate supply lines from remote sources of the ingredients. Typically, the diluent is cooled in a cooler for dispense of chilled beverages. The cooler is often positioned well away from the serving area, for example in a cellar, and the diluent lines pass from the cellar to the serving area in an insulated sheath known as a python to prevent the diluent warming up between the cooler and the tower. The concentrate lines may also be contained in the python and may be passed through the cooler.

Chilled post-mix soft drinks such as colas and flavoured sodas are typically dispensed by mixing a diluent with a concentrate in a ratio of approximately 5:1. Dispense of a drink having a temperature of about 4 to 5° C. can be achieved if the diluent temperature is about 2° C. and the concentrate temperature is about 14° C. Accurate control of the mixing ratio and temperatures of the diluent and concentrate is desirable to maintain an acceptable drink quality. Many factors can affect one or both of the mixing ratio and temperature, which, if left, could result in, dispense of drinks of unacceptable quality.

The present invention has been made from a consideration of the foregoing and seeks to provide a system for dispensing beverages, particularly soft drinks and more especially post-mix soft drinks.

One preferred aim of the invention is to provide a system for dispensing beverages, particularly soft drinks and more especially post-mix soft drinks in which dispense is monitored to detect a change in any of the factors affecting drink quality whereby dispense may be disabled and/or corrective action may be taken before the quality of dispensed drinks becomes unacceptable.

Another preferred aim of the invention is to provide a system for dispensing beverages, particularly soft drinks and more especially post-mix soft drinks in which dispense is monitored to collect information relating to the dispense for a variety of purposes including, but not limited to, the quality of the dispensed drinks and the functionality of the dispense equipment.

Yet another preferred aim of the invention is to provide a system for dispensing beverages, particularly soft drinks and more especially post-mix soft drinks in which dispense is monitored to provide information for analysis of functions such as, but not limited to, stock control, servicing/maintenance, profitability.

In one aspect, one or more aims of the invention may be achieved by providing a beverage dispense system, especially a system for dispensing soft drinks by mixing a diluent and a concentrate wherein sensor means is provided for monitoring one or more characteristics relating to the dispense and outputting a signal representative of the or each monitored characteristic, and a control system responsive to signals received from the sensor means for controlling operation of the dispense system.

In one embodiment, the control system includes diagnostic means responsive to signals received from the sensor means to detect a change in any characteristic affecting drink quality. The diagnostic means may be operable to provide a warning of the detected change allowing appropriate remedial action before quality of dispensed drinks is noticeably compromised. Alternatively or additionally, the diagnostic means may be operable to adjust operation of the system to mitigate the effect of the detected change on the quality of dispensed drinks.

The diagnostic means preferably includes a processor and more preferably a programmable processor for comparing the detected characteristics with desired characteristics and providing a warning or adjustment when the detected characteristic deviates from the desired characteristic by more than a pre-determined value. In some circumstances, the diagnostic means may cause the operation of the system to be adjusted to correct or compensate for the change in the detected characteristic and also cause a warning that servicing or maintenance work is required. In this way, the system may continue to operate to dispense drinks of acceptable quality until a service engineer can attend to carry out any necessary repairs. In circumstances where dispense of drinks of an acceptable quality cannot be maintained, the diagnostics means may cause shut-down of the dispense system until a service engineer has attended to repair the system.

The control system may be adapted for remotely accessing information and/or data from the diagnostic means. For example, the control means may include a modem or other suitable device for communication with a remote site via a personal computer, laptop, palmtop, mobile phone or other suitable device. In this way the performance (functionality) of the dispense system may be remotely monitored continuously or periodically whereby any changes indicating that the system is developing a fault that may require a service engineer before the next scheduled service visit can be detected and appropriate action taken before drink quality is significantly affected.

Alternatively or additionally, the control system may be adapted for locally accessing information and/or data from the diagnostic means. For example, the control means may include an information or data port for local interrogation via a personal computer, laptop, palmtop or other suitable device. In this way, when a service engineer makes a service call, whether as part of a regular maintenance program or as a result of a fault being detected, the engineer can locally access the control system to download information and/or data from the control system to assess the performance (functionality) of the system and identify the cause of any faults requiring repair.

Typically, the control system includes a memory for storing information and/or data relating to the performance (functionality) of the system from the diagnostic means and any other monitoring devices employed and, the memory is accessible via the information or data port. The control system may also be adapted to receive information or data to program the operation of the system and/or the collection and processing of information or data relating to the operation of the system. This may be carried out remotely or locally via appropriate communication links such as described above.

The control system may also be adapted to provide a visual indication of the status of the dispense system. For example, an array of lights may be employed to indicate the overall status of system and/or of individual components of the system. Thus, a system of traffic lights may be employed to indicate if the system and/or individual components of the system are operating satisfactorily such as a green light for pass, an amber light for border pass/fail and a red light for fail. This may allow a service engineer to identify a fault or a potential fault.

In another aspect, one or more aims of the invention may be achieved by a method of dispensing a beverage, preferably a soft drink, in which a diluent and a concentrate are mixed by monitoring characteristics of the system and/or the beverage and providing a control system including diagnostic means for detecting a change in any of the monitored characteristics and controlling operation of the system in response to the monitored characteristics.

According to another aspect, the invention provides a system for dispensing beverages, particularly soft drinks and more especially post-mix soft drinks in which dispense is monitored to detect a change in any of the factors affecting drink quality whereby dispense may be disabled and/or corrective action may be taken before the quality of dispensed drinks becomes unacceptable.

According to another aspect, the invention provides a system for dispensing beverages, particularly soft drinks and more especially post-mix soft drinks in which dispense is monitored to collect information relating to the dispense for a variety of purposes including, but not limited to, the quality of the dispensed drinks and the functionality of the dispense equipment.

According to another aspect, the invention provides a system for dispensing beverages, particularly soft drinks and more especially post-mix soft drinks in which dispense is monitored to provide information for analysis of functions such as, but not limited to, stock control, servicing/maintenance, profitability.

According to another aspect, the invention provides a system for dispensing beverages, particularly soft drinks and more especially post-mix soft drinks in which the system includes sensor means for monitoring a parameter of the system and diagnostic means responsive to the sensor means for detecting a change to a monitored parameter.

The diagnostic means may be operable to provide a warning of the detected change allowing appropriate remedial action before quality of dispensed beverages is noticeably compromised.

The invention will now be described in more detail, by way of example only, with reference to the accompanying drawings in which:

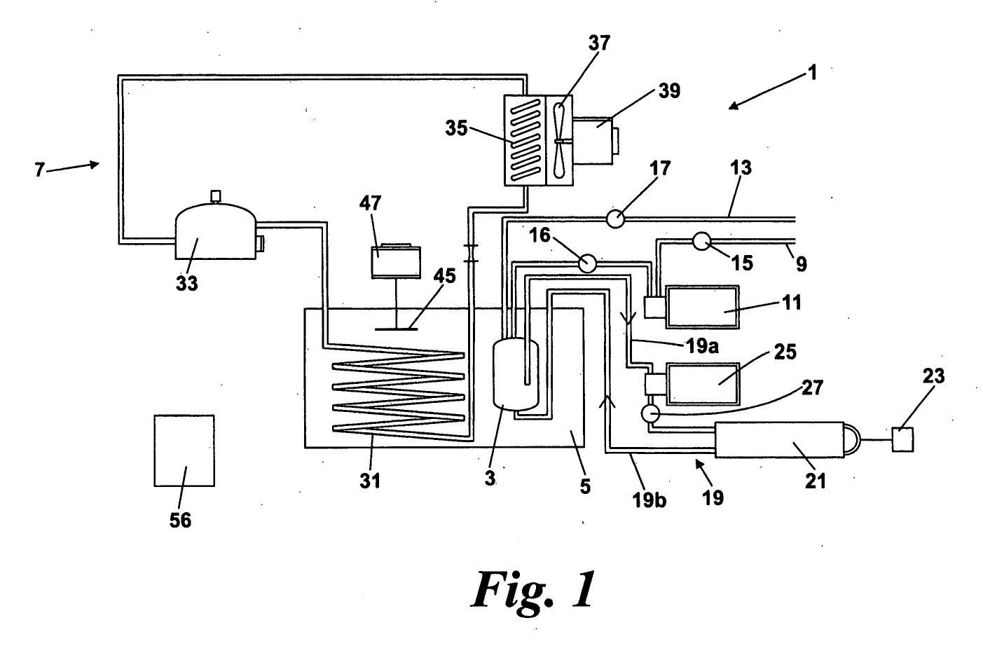

FIG. 1 is a schematic lay-out of a beverage dispense system embodying the invention; and

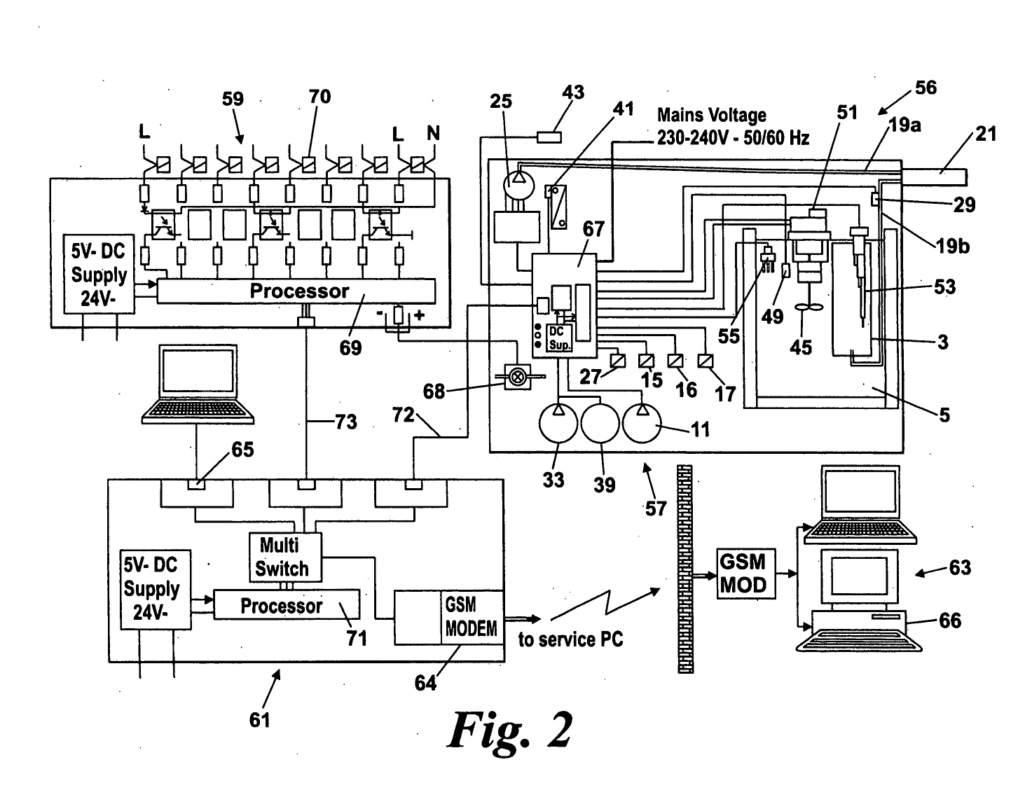

FIG. 2 is a diagrammatic lay-out of the control system for the dispense system of FIG. 1; and

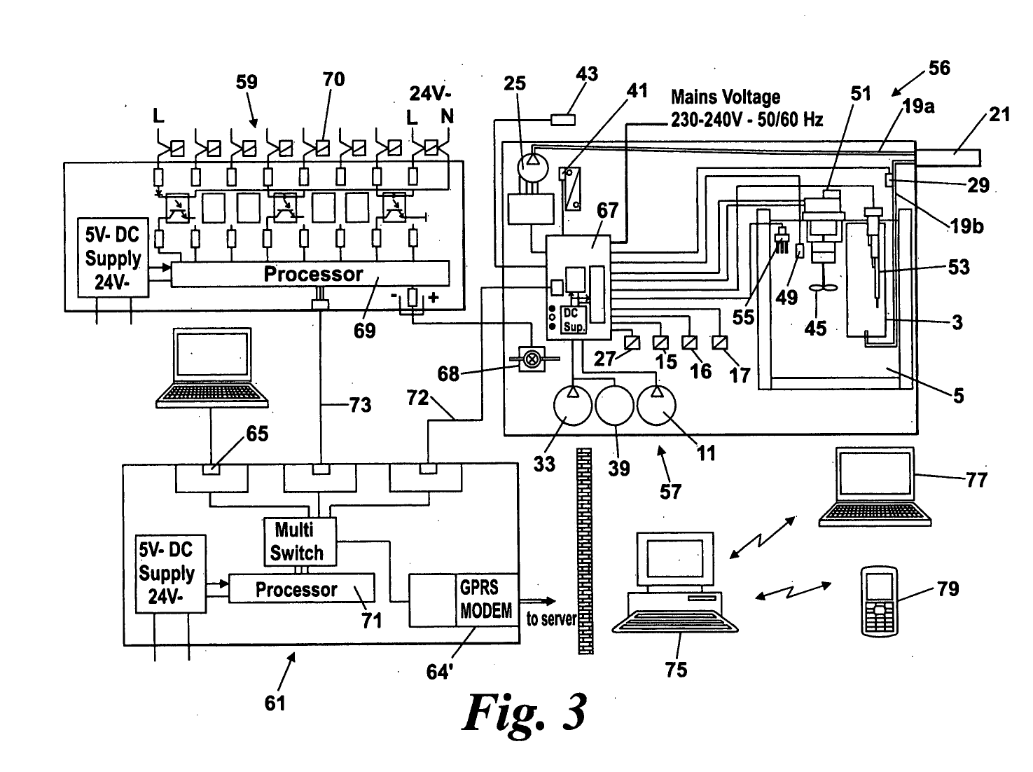

FIG. 3 shows a modification of the control system shown in FIG. 2.

Referring to FIGS. 1 and 2 of the accompanying drawings, a post-mix beverage dispense system 1 is shown for dispensing carbonated beverages such as colas, flavoured sodas and the like soft drinks in which a concentrate such as a syrup or flavour is mixed with carbonated water at the point of dispense.

The system 1 includes a carbonator tank 3 immersed in a waterbath 5 containing water cooled by a refrigeration circuit 7. In a modification the bath 5 could contain a different coolant such as an aqueous water/glycol mixture.

The carbonator tank 3 is connected to a source of still water such as mains water via a supply line 9 that includes a pump 11 to boost the water pressure for addition to the carbonator tank 3 where it is simultaneously carbonated by injecting a supply of carbonating gas delivered to the carbonator tank 3 via a supply line 13 connected to a source of the carbonating gas, for example a cylinder of carbon dioxide (not shown). The line 9 includes a pressure sensor 15 upstream of the pump 11 for monitoring the inlet water pressure. The performance of the pump 11 is monitored by a pressure sensor 16 downstream of the pump 11 for monitoring outlet water pressure from the pump 11. The line 13 includes a pressure sensor 17 for monitoring the inlet gas pressure to the carbonator tank 5.

The carbonator tank 5 is connected to a re-circulation loop 19 for circulating carbonated water to one or more dispense points located in a serving area such as a bar. Typically, the waterbath 5 is located remote from the serving area, for example in a cellar, and the re-circulation loop 19 has a supply line 19a and a return line 19b bundled with other lines (not shown) from the cellar to the serving area in an insulated tube bundle 21 commonly referred to as a python to reduce heat transfer between the lines contained in the tube bundle 21 and the environment.

The tube bundle 21 may include lines for supplying concentrate such as a syrup or flavour from a concentrate source in the cellar to the dispense point for mixing with the carbonated water. These concentrate lines may also pass through the waterbath 5 to cool the concentrate. Alternatively, the concentrate source may be provided in the serving area, for example under the bar and the concentrate is cooled in a heat exchanger (not shown) at the dispense point. For example, the heat exchanger may be located within a tower or similar dispense fitting and store sufficient cooled concentrate for dispense of one or more drinks. In this way the cooling requirement in the tube bundle 21 is reduced

In this embodiment, the re-circulation loop 19 is shown connected to one dispense point 23 but it will be understood that several dispense points may be provided in the same or different serving areas connected to the re-circulation loop 19.

The carbonated water is circulated in the loop 19 by a pump 25 located in the supply line 19a although it could be in the return line 19b. A temperature sensor 29 is provided for monitoring the temperature of the carbonated water returning to the carbonator tank 5. The temperature sensor 29 is shown in FIG. 2. The temperature of the carbonated water returning to the tank 5 may be used to control the speed of the soda pump 25. For example, the soda pump 25 may be slowed down where the cooling requirement of the carbonated water returning to the tank 5 is low such as may occur during periods where there is little or no dispense and speeded up when the demand for dispense is high. The performance of the pump 25 may be monitored by a pressure sensor 27 downstream of the pump 25 for monitoring the outlet pressure of the water from the pump 25.

The refrigeration circuit 7 includes an evaporator coil 31 located in the waterbath 5, a compressor 33 and condenser 35 cooled by air blown over the condenser 35 by a fan 37 driven by a motor 39. A temperature sensor 41 is provided for monitoring the temperature of the condenser 35 and a further temperature sensor 43 is provided for monitoring the ambient temperature. The sensors 41,43 are shown in FIG. 2.

The water in the waterbath 5 is cooled by heat exchange with refrigerant in the evaporator coil 31 and the water is circulated around the bath to improve heat exchange by means of an agitator 45 driven by a motor 47. A temperature sensor 49 is provided to monitor the temperature of the water in the waterbath 5 and a sensor 51 is provided to monitor the speed and/or current of the agitator motor 47. The sensors 49,51 are shown in FIG. 2. The agitator 45 may be speeded up or slowed down according to the cooling requirement.

In use, still water is carbonated and cooled in the carbonator tank 3 and supplied to the dispense point 23 for mixing with a concentrate or flavour for dispense of a chilled beverage. The dispense point 23 comprises a post-mix valve for mixing the carbonated water with the concentrate or flavour for dispense of a desired carbonated beverage. The dispense point 23 may comprise a plurality of post-mix valves for mixing the carbonated water with different concentrates or flavours for dispense of a range of beverages. At least one post-mix valve may also allow dispense of carbonated water without any concentrate or flavour. The dispense point 23 may also include one or more post-mix valves connected to a source of chilled still (un-carbonated) water for mixing the still water with a concentrate or flavour for dispense of a desired still drink. Where provided, at least one post-mix valve may also allow dispense of still water without any concentrate or flavour. Such post-mix valves will be familiar to those skilled in the art and are not described further herein.

Carbonated water that is dispensed is replaced by the addition of still water to the carbonator tank 3. A sensor 53 (FIG. 2) such as a level probe is provided for monitoring the level of water in the carbonator tank 3 and controlling the addition of water to the carbonator tank 3 to maintain the water level between upper and lower levels according to the demand for carbonated water. In periods of low demand for dispense of drinks, ice may form on the evaporator coil 31 which provides a thermal reserve to meet the increased cooling load during periods in which there is a high demand for dispense of drinks. More specifically, the temperature of the carbonated water circulating in the loop 19 is maintained by operation of the agitator 45 to pass the water in the bath 5 over the ice to cause the ice to melt and reduce the temperature of the water in the bath 5. The agitator 45 may be speeded up or slowed down according to the cooling requirement.

A sensor 55 (FIG. 2) such as a thickness probe is provided for monitoring the thickness of the ice bank formed on the evaporator coil 31 and controlling operation of the refrigeration circuit 7 in response thereto. In some applications, the agitator 45 may be combined with a pump (not shown) for circulating chilled water from the bath 5 in a re-circulation loop (not shown) to provide a source of coolant for other purposes. Where provided, the re-circulation loop extends within the tube bundle 21 to assist in maintaining the temperature of liquids transported to the serving area in other lines within the tube bundle 21 and/or to provide chilled water for cooling in the serving area.

The quality of the dispensed beverage is dependent on many factors including the temperature and carbonation level of the carbonated water delivered to the dispense point 23, the temperature of the concentrate or flavour supplied to the dispense point 23, and the mixing ratio of the carbonated water and the concentrate or flavour. These in turn are dependent on the operating characteristics of the system.

To achieve and maintain an acceptable drink quality a control system 56 is provided into which signals from the various sensors referred to previously are input along with signals from any additional sensors (not shown) for monitoring any other parameters as may be required. The control system is shown diagrammatically in FIG. 2, and includes a diagnostic circuit 57 for monitoring characteristics of the performance (functionality) of the dispense system, a throughput circuit 59 for monitoring use of the dispense system, and a central control circuit 61 for receiving information and/or data from the diagnostic circuit 57 and the throughput circuit 59. The control circuit 61 is adapted to provide remote communication with a service office shown generally by reference number 63 via a link 64. In this embodiment, the link 64 is a GSM (global system for mobile communication) connection to a central service computer 66 equipped with a GSM modem and service software. This computer 66 collects all the data for processing and/or distribution as required. Local communication with a user interface such as a laptop, palmtop or other hand held device may also be provided via an information or data port 65 using a wireless or wired connection to the user interface.

As shown, the diagnostic circuit 57 includes a controller 67 such as a microprocessor to which various sensors are connected for monitoring a range of characteristics impacting on the performance (functionality) of the system and thus the quality of the dispensed drink. The controller 67 compares the signals received from the various sensors with pre-determined values and/or ranges for the monitored characteristic to identify whether the monitored characteristic is inside or outside acceptable limits and to generate a warning of a failure condition when the monitored characteristic is outside the acceptable range under certain conditions, for example for a predetermined period of time or for a predetermined number of consecutive tests.

Examples of sensors, monitored characteristics, the conditions that are acceptable and the conditions giving rise to a warning of a failure are shown in Tables 1 and 2. Table 1 lists top level characteristics and Table 2 lists second level characteristics. Detection of a failure condition may cause shutdown of the system until the fault has been rectified. Detection of a characteristic that is just inside or outside the acceptable limits but does not generate a failure condition, may be used to provide an early warning of a fault which, if left, may lead to a failure condition and shutdown of the dispense system. In this way, the diagnostic circuit may allow developing faults to be rectified before causing total shutdown of the dispense system.

TABLE 1

| Sensor | Indicator | Monitored value | Failure condition |
|---|---|---|---|
| Ambient | out of specification | 5° C. up to 43° C. | Failure if temp higher |
| temp | conditions | OK, above red | for 1 hour |
| Water bath | system overdrawm, | 0° C. up to 3° C. OK, | Failure if temp higher |
| temp | defects in refrigeration | above red | for 1 hour (check |
| | circuit, main controller | | tendency) |
| | or ice probe | | |
| Soda return | blocked lines, | 0° C. up to 5° C. OK, | Failure if temp higher |
| temp | wear or failure of soda | above red | for 1 hour (check |
| | circuit motor or pump | | tendency) |
| CO₂ | gas supply condition, | Set to 4 bar, below | Failure if below 4 bar |
| pressure | blocked lines, | is red | |
| | supply exhausted | | |
| Water inlet | water supply condition, | Compare switch | Failure if out of |
| pressure | blocked lines, | status | specification for 1 hour |
| | down times of whole | | (check tendency) |
| | system | | |
| Voltage | power failure | OK between 200-260 V | Failure if out of |
| monitoring | | | specification for 1 hour |
| | | | (check tendency) |

TABLE 2

| Sensor | Indicator | Monitored value | Failure condition |
|---|---|---|---|
| Carbonator pump | function (on/off) blocked | Last 3 cycles of operation | Last 3 cycles below pressure |
| output pressure | lines wear or failure of | must be above the pressure | switch setting = red |
| | carbonator pump or motor | switch settings | |
| Agitator motor | blocked or defective | Compare RPM with current | Failure if current higher for |
| speed/current | agitator motor | draw of motor | 1 hour (check tendency) |
| Control board | compressor run time, | Total run time, number of | Compressor more than 10 cycles |
| data | carbonator pump run time, | cycles, power failures | per hour/carbonator pump more |
| | voltage monitoring | | than 10 per minute or single |
| | | | run time longer than 3 min |
| Condensing | Overheating condenser, | Last 3 cycles of operation - | Measure during last 3 |
| temperature | required cleaning or | if condensing temp = ambient | compressor cycles out |
| | refrigeration failure | temp indicates fridge failure | of specification |

The throughput circuit 59 includes a controller 69 such as a microprocessor for monitoring throughput of concentrate and comparing this with the total throughput of water over a predetermined period of time say 24 hours. In this embodiment, the throughput of concentrate is calculated statistically by clocking the opening times of a concentrate valve 70 in each concentrate line and/or by counting the actuations of the concentrate valves. The total throughput of water is provided by a flow sensor 68 such as a turbine in the water supply line 9. In this embodiment, eight valves 70 are shown but it will be understood that the number of concentrate lines and thus valves may be altered according to design of the post-mix dispenser. In a modification, the throughput of concentrate may be monitored by flowmeters or other suitable sensors provided in the concentrate lines. Monitoring the throughput of the concentrate can be used for a variety of purposes. For example, the concentrate throughput can be used to calculate/compare profitability of different products and/or different sites. The concentrate throughput can also be used to monitor the storage life of the concentrate and prevent dispense of drinks when the storage life of the concentrate is exceeded. Concentrate throughput can also be used for stock control to reorder concentrate according to actual and projected use so that new stock is available when the existing stock runs out.

The control circuit 61 includes a controller 71 for example a microprocessor that receives, analyses and stores data from the diagnostic circuit 57 and throughput circuit 59 via links 72 and 73 respectively. The data can be transmitted to the remote location via the link 64 or stored and accessed locally via the data port 65. The data can be used to identify any faults requiring an immediate service visit or developing faults likely to require a service visit before the next scheduled service visit. The control system may include a visual indication of the status of the system and individual parts of the system, for example a set of warning lights with green for OK, amber for border pass/fail and red for fail. This may assist identification of any parts requiring attention when an engineer attends and simplify the analysis of the data retrieved from the control circuit memory.

Referring now to FIG. 3, there is shown a modification to the system shown in FIG. 2 in which the GSM connection 64 is replaced by a GPRS (general packet radio service) connection 64′ with an interne web server 75. In this way, all data is collected and stored on the web server 75 and the service software is a web application allowing remote connection to the web server 75 from any location, for example an office computer 77, laptop, palmtop or mobile phone 79, without requiring a modem or local software to access the data on the web server 72. In other respects the system of FIG. 3 is the same as FIG. 2.

In a further modification (not shown) of particular benefit to the web application, the dispense system can be placed in a sleep or energy saving mode where certain components of the cooler, for example compressor 33 can be switched off and/or the agitator 45, and/or the carbonated water re-circulation pump 25 slowed to save energy in periods of low or no cooling demand. This is especially suitable where the concentrate lines are taken out of the python and the concentrate is cooled locally at the point of dispense. As a result, the cooling requirement in the python is reduced with the result that, after warming up, the time to cool the python down may be reduced from around 12 to 24 hour to as little as 1 hour, allowing the cooler to be placed in the sleep mode overnight with substantial energy savings. The times for the sleep mode can be stored on the web server allowing these to be set individually for each location and to be adjusted as necessary according to the monitored performance of the system.

Other benefits and advantages of the invention will be apparent to those skilled in the art and modifications and improvements that can be made to the system without departing from the concepts discussed herein are deemed within the scope of the invention as defined in the claims.

What is claimed is:

1. A beverage dispense system comprising sensor means for monitoring one or more characteristics relating to dispense of a beverage and outputting a signal representative of the or each monitored characteristic, and a control system responsive to signals received from said sensor means for controlling operation of the dispense system.

2. A beverage dispense system according to claim 1, wherein said control system includes diagnostic means responsive to signals received from said sensor means to detect a change in any characteristic affecting beverage quality.

3. A beverage dispense system according to claim 2, wherein said diagnostic means is operable to provide a warning of the detected change allowing appropriate remedial action before quality of dispensed beverages is noticeably compromised.

4. A beverage dispense system according to claim 2, wherein, said diagnostic means is operable to adjust operation of the system to mitigate the effect of the detected change on the quality of dispensed beverages.

5. A beverage dispense system according to claim 2, wherein said diagnostic means has means for comparing the detected characteristics with desired characteristics and providing a warning or adjustment when the detected characteristic deviates from the desired characteristic by more than a pre-determined value.

6. A beverage dispense system according to claim 5, wherein, said diagnostic means causes operation of the system to be adjusted to correct or compensate for the change in the detected characteristic and also cause a warning that servicing or maintenance work is required.

7. A beverage dispense system according to claim 5, wherein, said diagnostics means causes shut-down of the dispense system where dispense of drinks of an acceptable quality cannot be maintained until a service engineer has attended to repair the system.

8. A beverage dispense system according to claim 2, wherein said control system is adapted for remotely accessing information and/or data from said diagnostic means.

9. A beverage dispense system according to claim 8, wherein, said control system allows remote access to information and/or data by a communication link via the interne.

10. A beverage dispense system according to claim 2, wherein said control system is adapted for locally accessing information and/or data from said diagnostic means.

11. A beverage dispense system according to claim 10, wherein, said control system includes an information or data port for local interrogation.

12. A beverage dispense system according to claim 2, wherein said control system includes a memory for storing information and/or data relating to the performance (functionality) of the system from said diagnostic means.

13. A beverage dispense system according to claim 2, wherein said control system is adapted to receive information or data to program operation of the system and/or collection and processing of information or data relating to operation of the system.

14. A beverage dispense system according to claim 2, wherein said control system is adapted to provide a visual indication of the status of the dispense system.

15. A beverage dispense system according to claim 1, comprising a system for dispensing soft drinks by mixing a diluent and a concentrate.

16. A method of dispensing a beverage by monitoring characteristics of the system and/or the beverage and providing a control system including diagnostic means for detecting a change in any of said monitored characteristics and controlling operation of the system in response to said monitored characteristics.

17. A method according to claim 16, wherein said control system further includes a throughput circuit for monitoring use of the dispense system, and the method further comprises the steps of using said throughput circuit to monitor throughput of concentrate for dispense of post-mix beverages, and using said concentrate throughput to calculate/compare profitability, or to monitor storage life of concentrate, or for stock control of concentrate.

18. A beverage dispense system comprising sensor means for monitoring one or more characteristics relating to dispense of a beverage and outputting a signal representative of the or each monitored characteristic, and a control system responsive to signals received from said sensor means for controlling operation of the dispense system, said control system including a diagnostic circuit for monitoring characteristics of the performance of the dispense system and a throughput circuit for monitoring use of the dispense system.

19. A beverage dispense system according to claim 18, comprising a post-mix system for dispensing soft drinks by mixing a diluent and a concentrate and said throughput circuit monitors throughput of concentrate.

20. A beverage dispense system according to claim 19, wherein throughput of concentrate is used to calculate/compare profitability, or to monitor storage life of concentrate, or for stock control of concentrate.
